(19) United States
(12) Patent Application Publication
(10) Pub. No.: US 2022/0226870 A1
(43) Pub. Date: Jul. 21, 2022

(54) METHOD AND APPARATUS FOR DETERMINATION OF TWIST ANGLE DURING A ROLLING OPERATION

(71) Applicant: VALLOUREC DEUTSCHLAND GmbH, Dusseldorf (DE)

(72) Inventors: Mark VAN DER LOGT, Boulogne-Billancourt (FR); Ralf VOLLES, Boulogne-Billancourt (FR); Christian KLEMPEL, Boulogne-Billancourt (FR)

(73) Assignee: VALLOUREC DEUTSCHLAND GmbH, Dusseldorf (DE)

(21) Appl. No.: 17/608,599

(22) PCT Filed: May 6, 2019
(86) PCT No.: PCT/EP2019/061578

§ 371 Date: Nov. 3, 2021

(51) Int. Cl. B21B 19/04; B21B 19/06; B21B 38/04

(52) U.S. Cl. CPC B21B 19/04; B21B 19/06; B21B 2275/06; B21B 2261/08; B21B 38/04

(57) ABSTRACT

A non-destructive method for determination of twist angle of an outlet product during rolling of an inlet product into said outlet product, comprising the steps of measuring a rotational inlet speed of the inlet product during said rolling, measuring a rotational outlet speed of the corresponding outlet product during said rolling in order to determine a delta rotation, measuring a longitudinal speed and determining a twist angle from said delta rotation and said longitudinal outlet and/or inlet speed.

The present invention belongs to the field of seamless tube making by cross-roll piercing or elongation, and relates to a method for non-destructive testing in the production process of hot- rolled pipes, in particular hollow tubes made of steel, commonly called hollows. The invention also relates to an apparatus for performing this method.

In seamless tube making by cross-roll piercing, a cylinder steel blank, or billet, is introduced as an inlet product on an inlet side of a rolling apparatus and between rolls having a predetermined inclination in relation to a billet axis. The rolls subjects the billet to a stress greater than the yield strength of the material of the billet. The rolls drag the billet against a plug, which forces outwardly the material from the center of the billet and pull the material of the billet on the outside and against the backside of the rolls, thus producing an outlet product called hollow with respectively an internal diameter and an external diameter. During cross-roll piercing, billet and hollow formed from the billet form a workpiece. The hollow exit the rolling apparatus on an outlet side of the rolling apparatus.

In an elongation process by cross-rolling, a hollow as inlet product is introduced on an inlet side of a rolling apparatus in a similar manner as a billet, and is forced on the outlet side of said rolling apparatus. An inside tool may be used such as a plug or a mandrel. The corresponding outlet product is called a shell.

During cross-roll piercing or elongation, the rolls rotate the workpiece. At the end of the operation of piercing the billet has become a hollow. At the end of the operation of elongation the hollow has become a shell. Important elements of a cross rolling mill are the rolls and the plug or mandrel. The rolls all turn in the same sense and act like a gear together with the rolling material that is positioned in the center. Thus, the material turns in a direction opposite to the direction of rotation of the rolls. The inclined position of the roll leads to a screwed movement.

Either the rolls may have the form of a barrel, i.e. the roll axes are positioned in planes that are parallel to the axis of the rolling material, or they have the form of a cone. With the cone, the roll axes would cross the workpiece axis in one point if the feed angle was zero.

Such a rolling apparatus is described in patent U.S. Pat. No. 3,719,066.

The piercing or elongation process causes a twisting in the outlet product as a result of the different surface speeds of the rolls along the material axis. The twisting is dependent on multiple factors, among them the expansion coefficient, piercer type, feed angle, toe angle, roll geometry, material grade, feed efficiency. Thus, the twisting is dependent from the rolling apparatus, the materials, and the rolling process parameters.

Also, the rolling process may cause defects in the hollow tube or shell produced. This is why finished hollow tubes or shells are inspected in order to detect these defects. Outer surface defects can be transverse, longitudinal, or oblique. Oblique defects have an orientation with an angle between transverse and longitudinal orientations. Defects can be located at the outer surface of the hollow or shell. Outer surface oblique defects are generally linked to the orientation of the twisting and can be detected by UT easily if the twisting angle is known. This is why there is an advantage to identify the twist angle of a hollow tube or shell to subsequently estimate the orientation of outer surface oblique defects, and consequently to improve the detection of these oblique defects by non- destructive inspection such as ultrasonic inspection.

One known method to evaluate the twist angle is to make a notch on the external surface of a representative billet, said notch extending all along the billet and thus obtaining a grooved billet having a longitudinal groove. Then the grooved billet is pierced. The twist angle can be evaluated after piercing by measurement of the imprint of this groove on the hollow. This solution is not practical and is costly, as it demands many trials and it is necessary to make at least one trial per set of parameters. This solution is time and resources consuming.

Thus there is a need for a non-destructive method and a device that leads to the determination of twist angle in an efficient manner and which is compatible of industrial paces.

Advantageously, the inventive method and apparatus are compatible with all different cross rolling processes, where after piercing, elongation processes are done, such as Mannesmann rolling, Pilger rolling, Plug rolling, Mandrel rolling.

Advantageously, this inventive method is a non-destructive method. Also, the twisting can be determined, independently from all parameters of a cross rolling stand and from the piercing process.

The invention relates to a non-destructive method for determination of twist angle of an outlet product during rolling of an inlet product into said outlet product, comprising the steps of:
Measuring a rotational inlet speed of the inlet product during said rolling,
Measuring a rotational outlet speed of the corresponding outlet product during said rolling,
Measuring a longitudinal outlet and/or inlet speed of the said respectively corresponding outlet product and/or inlet product,
Determining a delta rotation from said rotational inlet speed and said rotational outlet speed
Determining a twist angle from said delta rotation and said longitudinal outlet and/or inlet speed.

According to one aspect, the measures of rotational inlet speed, rotational outlet speed, longitudinal outlet and/or inlet speed may be taken from a starting time (t₀) to a finish time (t₁). According to another aspect, the measures of rotational inlet speed may be taken from an inlet starting time to an inlet finish time, and the measures of rotational outlet speed are taken from an outlet starting time and an outlet finish time, said inlet starting time and inlet finish time defining an inlet time window, said outlet starting time and outlet finish time defining an outlet time window, and inlet time window and outlet time window having a shared time window having a starting time (t₀) to a finish time (t₁).

The method may further comprises the step of measuring outlet outside diameter of the outlet product.

The twist angle (TA) may be determined by the formula (F)

$$TA = a tan ( \frac{Delta \times {OD}_{H} \times π}{{\int }_{{t}_{0}}^{{t}_{1}} {V}_{{H}_{T}}} ) \qquad ( F )$$

where

Delta is the difference of turns between the number of performed turns of the outlet product and the number of performed turns of the inlet product in the time window from the starting time t₀ to the finish time t₁ or the shared time window,

OD_{H} is an outside diameter of the outlet product,

V_{HT} is the longitudinal outlet speed of the outlet product

In an embodiment, the longitudinal outlet speed V_{HT} is replaced by the longitudinal inlet speed V_{BT} multiplied by an elongation factor kₑ.

The method may further comprise the step of measuring inlet outside diameter of the inlet product.

According to one aspect, outlet speed measures and outlet outside diameter measures may be made in a same plane orthogonal to the axis of the outlet product.

According to another aspect, inlet speed measures and inlet outside diameter measures may be made in a same plane orthogonal to the axis of the inlet product.

The starting time (t₀) and the finish time (t₁) may be chosen in a steady state phase to determine more accurately the twist angle.

In one embodiment, the rolling operation may be a piercing operation where the inlet product is a billet and the outlet product is a hollow.

In another embodiment, the rolling operation may be an elongation operation where the inlet product is a hollow and the outlet product is a shell.

The invention is also an apparatus for non-destructive determination of twist angle during rolling of an inlet product into an outlet product comprising:
a first inlet sensor adapted to measure speed of the inlet product,
a first outlet sensor adapted to measure speed of the outlet product,
an outlet outside diameter sensor (60),
an electronic configured to determine the twist angle of said outlet product based on measures performed by the said sensors during rolling.

The first outlet sensor (58) may be adapted to measure a transversal outlet speed of the outlet product and the apparatus may further comprise a second outlet sensor (57) adapted to measure a longitudinal outlet speed of the outlet product.

The first inlet sensor (53) may be adapted to measure the transversal inlet speed of the inlet product.

According to one embodiment, the apparatus may comprise a second inlet sensor (52) adapted to measure the longitudinal inlet speed of the inlet product.

The apparatus may further comprise an inlet outside diameter sensor (54).

In a variation, the first inlet sensor (53), the second inlet sensor (52) and the inlet outside diameter sensor (54) may be arranged such that the measures are effected in a same inlet measurement plane (55).

In a variation, the first outlet sensor (58), the second outlet sensor (57) and the outlet outside diameter sensor (60) may be arranged such that the measures are effected in a same outlet measurement plane (59).

### LIST OF FIGURES

FIG. 1 shows schematically a rolling gap of a cross rolling stand

FIG. 2 shows schematically a developed view of an outlet product with an imprint of a twist

FIGS. 3a and 3b show schematically a grooved billet and the resulting grooved hollow after piercing

FIG. 4 shows a chart of rolling force measures during piercing of a billet

FIG. 5 shows a schematic view of an apparatus according to the invention

### DETAILED DESCRIPTION

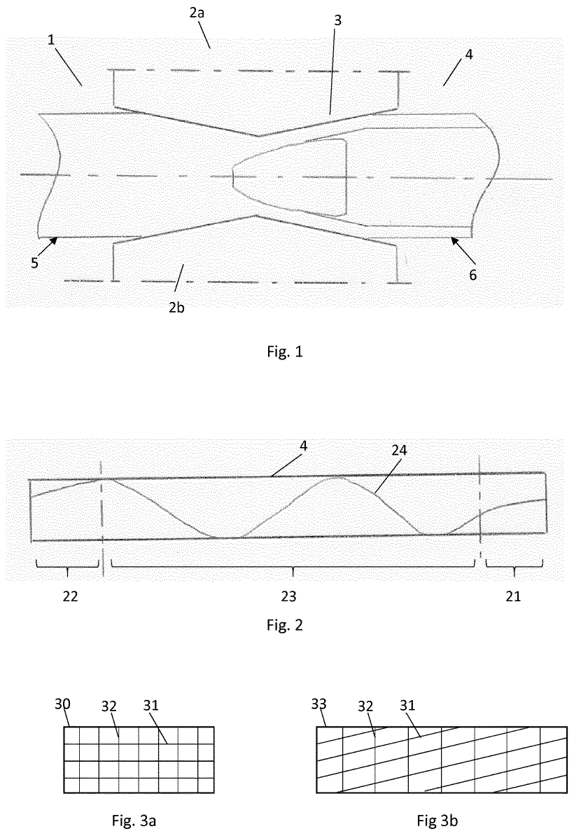

The general principle of a rolling process of a tube as illustrated in FIG. 1. The principle will be described hereafter in case of piercing, but elongation process follows the same basic steps. The process starts from a round bar commonly called billet (1) which is heated to a rolling temperature and then introduced in the rolling apparatus through the inlet side (5) between two inclined, contoured rolls (2a, 2b) driven in the same direction of rotation. The billet (1) is pierced by an internal plug (3). The billet (1) is thus rolled in one direction over the inside plug (3) and between the contoured rolls (2a, 2b) forming a rolling gap. The billet (1) transforms on the other side of the internal plug (3) into a hollow (4). The hollow exits the rolling apparatus on the outlet side (6). The apparatus can be configured to increase or keep or slightly decrease the outside diameter of the hollow in comparison with outside diameter of the billet. The apparatus can be configured to produce a hollow with a predetermined wall thickness.

Tests have been conducted to apprehend how a billet (1) is deformed during piercing. Trials were carried out with billets on which grooves were machined to form a grid with an edge length of 60 by 60 mm. The depth of grooves of the grid was 3 mm and the width was 4 mm. 20 billets were made and processed through various conditions of rolling.

FIG. 2 shows schematically a developed view of a hollow (4). Said hollow (4) comprises a first end portion (21) or head end, a central portion or filet part (23), a second end portion (22) or tail end. A twist line (24) is shown. It is possible to identify three areas presenting different patterns of the twist line (24). The twist line (24) forms a sensibly regular ellipse along the filet part (23). This twist line (24) is more irregular at the head end (21) and tail end (22). Thus the twist line (24) in the filet part (23) corresponds to a sensibly constant twist angle along the filet part (23), whereas the twisting at the ends is influenced by filling and clearing of the rolling gap. In fact, these three areas correspond to three phases of the piercing process: the head end portion of the hollow is produced during a biting or rolling start, the filet part (23) is produced during a stationary or steady state phase, the tail end (22) is produced during an ending or rolling end phase.

The behavior of the steel was observed throughout testing. FIG. 3a shows schematically in a developed representation a special grooved inlet product: a billet (30) with straight axial grooves (31) and straight circumferential grooves (32). Before rolling, the grooved billet (30) has straight axial grooves (31) oriented longitudinally and circumferential grooves (32) oriented transversally forming a pattern of grid. Several billets of different dimensions were made according to this pattern. The billets were heated and rolled according to several different parameters such as expansion coefficient and different hollow wall thicknesses. After piercing of the grooved billets (30), it was observed on the corresponding grooved hollows (33) that the circumferential grooves (32) remain oriented transversally and are more spaced one from the other, whereas the axial grooves (31) have an angle in relation with the longitudinal direction and form spirals, as it is represented schematically on FIG. 3b. Thus the action of the rotating rolls (2a, 2b) deforms spirally the metal.

It was observed that the deformed pattern was regular along the grooved hollow (33) except in start and end of said grooved hollow (33), and the spirals having about a same angle, said angle being sensibly constant, to the exception of the ending parts of the tubes where deformations are less important, with a spiral angle lower than the spiral angle observed on the major part of the body of a tube.

Several mathematical models have been tested starting from these tests. It has been found an approach in which the twist angle is function of the component of relative displacement of a point of the hollow tube from a first time to a second time, and also function of the amount of relative rotation of the hollow tube in relation to the rotation of the billet during said displacement from said first time to said second time.

Also, assessing displacement of the billet or the hollow can be done through integrating speed of the tube at a precise coordinate over the time.

Determination of a practical twisting at the head end and at the tail end is possible with the method of the invention, but less accurate as the twisting varies along said head end and tail end. Moreover, it has not real interest for the purpose of subsequent non-destructive testing as the variation of the angle is not taken into account at the time being in current testing machines. Then such twisting in head end and tail end is considered as an undefined twist for the purpose of non-destructive testing.

It is interesting to define the undefined twist length, either head end twist length or tail end twist length. The undefined twist length can be determined by the following steps:
measuring the roll force during rolling of a billet or measuring a roll torque during rolling of a billet,
measuring a transversal speed of the hollow,
determining a first time window between a first time when roll force or roll torque raises from zero to a second time when the roll force or roll torque reaches a predetermined amount of force or a predetermined amount of torque respectively,
determining from the transversal speed measurement and the first time window the length of a biting (21)
determining a second time window between a third time when roll force or roll torque decreases from a predetermined amount of force or a predetermined amount of torque to a fourth time when the roll force or roll torque reaches sensibly zero,
determining from the transversal speed measurement and the second time window the length of the clearing (22)

Thus determining the lengths of undefined twisting angle at tail end and head end.

The head end twist length or tail end twist length can be determined independently.

The steady-state phase can be defined as roll force or roll torque being defined as 92% of maximum rolling force applied during piercing.

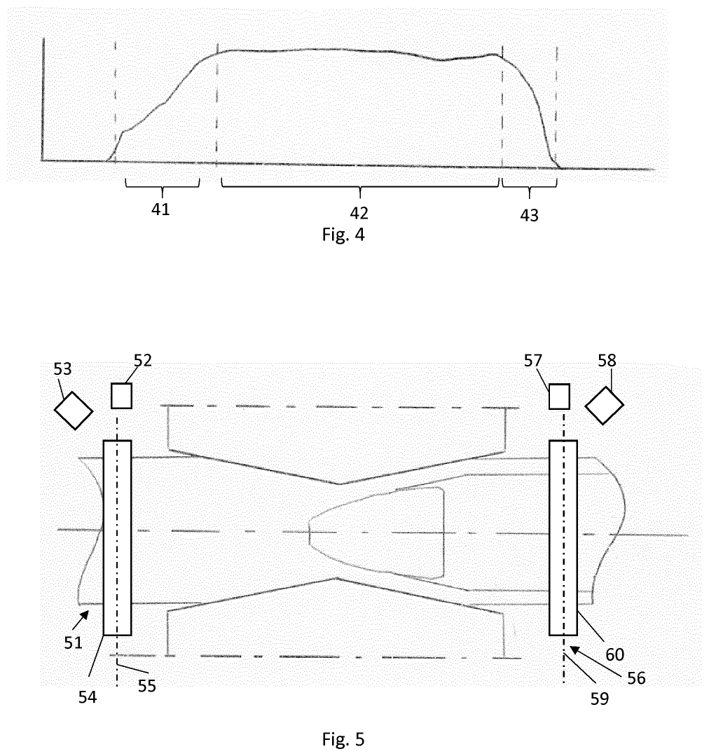

FIG. 4 illustrates a curve representing a typical roll torque function of time, with the biting (41) with an increasing torque up to a sensibly flat portion of the curve corresponding to the steady-state phase (42), that may include some irregularities while the torque remains over 92% of the maximum torque applied, and finishing on a clearing which corresponds to a decreasing of roll torque amount.

The established model mainly works for a steady-state phase. The steady-state phase corresponds to the working time when rolling speed or torque/force is substantially constant, or otherwise defined, the working time excluding the initial acceleration at start of rolling and the final decrease of speed at the end of rolling. Steady-state phase can also be called stationary process. As can be seen on FIG. 4, when the tube is subjected to rolling, there is at the start of rolling (41) a progressive increase of rolling forces exerted on the billet and an increase of speed, as well as there are a lowering of rolling forces and speed at end of rolling (43). This is due at least to the entry and the exit in and from the rolls of the billet and tube. Finally, the model is more appropriate for the steady-state phase (42) where the rolling forces are sensibly constant, with rolling speed also sensibly constant that is a variation of less than 10% over time.

Steady state phase can be determined based on roll force and roll torque readings.

According to one aspect of the invention, the twist angle (TA) is determined by the formula (F)

$$TA = a tan ( \frac{Delta \times {OD}_{H} \times π}{{\int }_{{t}_{0}}^{{t}_{1}} {V}_{{H}_{T}}} ) \qquad ( F )$$

where

Delta is the difference of turns between the number of performed turns of the outlet product, that is a hollow or a shell, and the number of performed turns of the inlet product, that is a billet or a hollow, in the time window from the starting time t₀ to the finish time t₁,
Delta=turnsₒᵤₜₗₑₜ−turnsᵢₙₗₑₜ
When applied to piercing operation, the formula becomes
Delta=turns_{hollow}−turns_{billet}

Turnsₒᵤₜₗₑₜ may be determined by dividing the integral of transversal outlet speed between the starting time t₀ and the finish time t₁, measured on the external surface of said outlet product, by the outside diameter of the outlet product, being a hollow or a shell.

Turnsᵢₙₗₑₜ may be determined by dividing the integral of transversal inlet speed between the starting time t₀ and the finish time t₁, measured on the external surface of said inlet product, by the outside diameter of the inlet product being a billet or a hollow.

The speed measures are surface speed measures. Said measures may be done by optical means. Said measures can be done by speed laser sensors. An advantage of such sensor is that speed measures can be done on hot material. Indeed, the billet and hollow, shell, may be at temperatures of several hundreds of degrees for rolling. Tests have been conducted on hot and cold materials and it has been determined that such laser sensors are not sensible on difference of temperatures of the material.

Alternatively, it may be also possible to assess the rotational outlet or inlet speeds directly, thanks to a sensor measuring directly a rotational speed (in rad/s) instead of linear transversal speed (in length unit divided by time unit such as seconds), without necessity of measure of outside diameter.

OD_{H} is the outside diameter of the hollow tube.

The outside diameter of the billet and the hollow may be measured by optical sensors.

The starting time t₀ to the finish time t₁ may correspond to a chosen time window. Preferentially, the starting time t₀ to the finish time t₁ are chosen to be into the steady-state phase of piercing of the workpiece.

V_{HT} is the longitudinal outlet speed of the outlet product. As for rotational speed measures, this measure is done by optical means such as a laser sensor.

Alternatively, longitudinal inlet speed of the inlet product can be used, with a multiplier coefficient kₑ corresponding to the elongation factor.

In a variation, a first starting time and a first finish time can be chosen for the measures done on the inlet product, and a second starting time and a second finish time can be chosen for the measures done on the outlet product; respectively defining a first time window or a second time window. In this case, the formula is applied to a shared time window, common to first time window and second time window. Alternatively, time windows of same duration are selected in first time window and second time window and chosen in steady state phase to apply formula (F).

The invention is also about an apparatus for measuring twist angle of a hollow which comprises

(1) An inlet module (51)
The inlet module (51) comprises:
An inlet transversal speed measuring device (53)

(2) An outlet module (56)
The outlet module comprises:
An outlet transversal speed measuring device (57) and an outlet longitudinal speed measuring device (58)
Preferably, the outlet transversal speed measuring device and outlet longitudinal speed measuring device are arranged such that the measures are effected in a same plane called outlet measurement plane (59). This outlet measurement plane is sensibly perpendicular to the longitudinal axis (X) of the material in the cross roll apparatus.
An outlet outside diameter measuring device (60)
The outside diameter measuring devices can be a rotating STEELMASTER SMR Gauge from ZUMBACH. The principle of this measuring device is based on an optical measure realized by laser in a rotating or static mode.

The speed measuring devices can be laser measuring devices such as laser surface velocimeter LSV_065 from Polytec.

The inlet module (51) may comprise an inlet longitudinal speed measuring device (54). Preferably, the inlet transversal speed measuring device and inlet longitudinal speed measuring device are arranged such that the measures are effected in a same plane called measurement plane inlet (54). This inlet measurement plane is sensibly perpendicular to the longitudinal axis (X) of the material in the cross roll apparatus. It means that measures are effected at locations of the surface of the tube located in the said measurement plane. This feature enables accurate measurements.

The inlet module (51) may comprise an inlet outside diameter measuring device (55) to retrieve and process automatically the outside diameter of the inlet product, even if outside diameter of an inlet product, such as a billet, is generally known.

According to one aspect, transversal speed measuring device and longitudinal speed measuring device as well as outside diameter measuring device—either outlet or inlet devices respectively—are arranged such that the spots or surfaces where measures are taken with laser rays are located in a same plane orthogonal to the centerline, called inlet or outlet measurement plane (55; 59). This means that speed measures and hollow OD measures are made in a same plane. The advantage is that the accuracy of the computed twist angle is improved.

The measurement planes (inlet and outlet) should be as close as possible to the rolling gap.

This method is advantageously non-destructive.

This method works for all steel grades, or any kind of material and it also have the advantage to work for every dimension scenario, for any outer diameter of the billets and any outer diameter of the resulting tubes, and thus also for a various kind of ratio between billet outer diameter and hollow outer diameter.

In addition, this method can be operated on every single tube produced, and is not dedicated to specific tubes.

Tests were conducted to check the impact of bar rotation and axial movement on measurement accuracy. Firstly, a slow movement was imprinted on a cold tube at a first axial speed, and measurement of outside diameters were done. The experiment was repeated with a second longitudinal speed faster than the first longitudinal speed. The impact on outside diameter measurement was not significant, since a difference of 0.05 mm was observed for an outside diameter measured between 89.1 to 89.3 mm. Tests were conducted with different rotational speeds. The tests showed no significant impact on the mean outside diameter measured.

Twist angles can be calculated at several locations along the hollow. An average twist angle can be calculated from the different twists angles of different locations along the hollow.

1. A non-destructive method for determination of twist angle of an outlet product during rolling of an inlet product into said outlet product, comprising the steps of:
measuring a rotational inlet speed of the inlet product during said rolling,
measuring a rotational outlet speed of the corresponding outlet product during said rolling,
measuring a longitudinal outlet and/or inlet speed of the said respectively corresponding outlet product and/or inlet product,
Determining determining a delta rotation from said rotational inlet speed and said rotational outlet speed, and
Determining determining a twist angle from said delta rotation and said longitudinal outlet and/or inlet speed.

2. Method The method according to claim 1, further comprising the step of measuring outlet outside diameter of the outlet product.

3. Method The method according to claim 1, wherein the measures of rotational inlet speed, rotational outlet speed, longitudinal outlet and/or inlet speed are taken from a starting time (t₀) to a finish time (t₁).

4. Method The method according to claim 1, wherein the measures of rotational inlet speed are taken from an inlet starting time to an inlet finish time, and the measures of rotational outlet speed are taken from an outlet starting time and an outlet finish time, said inlet starting time and inlet finish time defining an inlet time window, said outlet starting time and outlet finish time defining an outlet time window, and inlet time window and outlet time window having a shared time window having a starting time (t₀) to a finish time (t₁).

5. The method according to claim 3, wherein the twist angle (TA) is determined by the formula (F)
$$TA = a tan ( \frac{Delta \times {OD}_{H} \times π}{{\int }_{{t}_{0}}^{{t}_{1}} {V}_{{H}_{T}}} ) \qquad ( F )$$
where
Delta is the difference of turns between the number of performed turns of the outlet product and the number of performed turns of the inlet product in the time window from the starting time t₀ to the finish time t₁ or the shared time window,
OD_{H} is an outside diameter of the outlet product,
V_{HT} is the longitudinal outlet speed of the outlet product.

6. Method The method of claim 5, where the longitudinal outlet speed V_{HT} is replaced by the longitudinal inlet speed V_{BT} multiplied by an elongation factor kₑ.

7. The method according to claim 1, further comprising the step of measuring inlet outside diameter of the inlet product.

8. The method according to claim 1, wherein the outlet speed measures and outlet outside diameter measures are made in a same plane orthogonal to the axis of the outlet product.

9. The method according to claim 7, wherein inlet speed measures and inlet outside diameter measures are made in a same plane orthogonal to the axis of the inlet product.

10. The method according to claim 1, wherein the starting time (t₀) and the finish time (t₁) are chosen in a steady state phase.

11. A non-destructive method according to claim 1, wherein the rolling operation is a piercing operation and where the inlet product is a billet and the outlet product is a hollow.

12. A non-destructive method according to claim 1, wherein the rolling operation is an elongation operation and where the inlet product is a hollow and the outlet product is a shell.

13. An apparatus for non-destructive determination of twist angle during rolling of an inlet product into an outlet product comprising:
a first inlet sensor adapted to measure speed of the inlet product,
a first outlet sensor adapted to measure speed of the outlet product,
an outlet outside diameter sensor, and
an electronic configured to determine the twist angle of said outlet product based on measures performed by the said sensors during rolling.

14. The apparatus according to claim 13, wherein the first outlet sensor is adapted to measure a transversal outlet speed of the outlet product and that the apparatus further comprises a second outlet sensor adapted to measure a longitudinal outlet speed of the outlet product.

15. The apparatus according to claim 13, wherein the first inlet sensor is adapted to measure the transversal inlet speed of the inlet product.

16. The apparatus according to claim 15, further comprising a second inlet sensor adapted to measure the longitudinal inlet speed of the inlet product.

17. The apparatus according to claim 13, further comprising an inlet outside diameter sensor.

18. The apparatus according to claim 17, wherein the first inlet sensor, the second inlet sensor and the inlet outside diameter sensor are arranged such that the measures are effected in a same inlet measurement plane.

19. The apparatus according to claim 14, wherein the first outlet sensor, the second outlet sensor and the outlet outside diameter sensor are arranged such that the measures are effected in a same outlet measurement plane.
